(19) United States
(12) Patent Application Publication
(10) Pub. No.: US 2016/0299677 A1
(43) Pub. Date: Oct. 13, 2016

(54) EQUALIZER SETTING DEVICE, EQUALIZER SETTING METHOD, MEDIUM STORING EQUALIZER SETTING PROGRAM

(71) Applicant: YAMAHA CORPORATION, Hamamatsu-shi (JP)

(72) Inventor: Kotaro TERADA, Hamamatsu-shi (JP)

(21) Appl. No.: 15/096,654

(22) Filed: Apr. 12, 2016

(30) Foreign Application Priority Data
Apr. 13, 2015 (JP) 2015-081566

(51) Int. Cl. G06F 3/0484; H04H 60/04

(52) U.S. Cl. CPC G06F 3/04847; H04H 60/04

(57) ABSTRACT

An equalizer setting device includes a category information acquisition unit configured to acquire category information indicating a category set for a signal processing channel; and a unit configured to display, on a display unit, at least one of a display element indicating a frequency range corresponding to the category set for the signal processing channel or a display element indicating a distinctive frequency band corresponding to the category.

### CROSS-REFERENCE TO RELATED APPLICATION

The present application claims priority from Japanese Application JP2015-081566, which is hereby incorporated by reference into this application.

### BACKGROUND OF THE INVENTION

1. Field of the Invention

One or more embodiments of the present invention relates to an equalizer setting device configured to enable easy setting of an equalizer to be applied to a device for processing an acoustic signal, for example, a digital mixer.

2. Description of the Related Art

A processing device for an acoustic signal, for example, a digital mixer, includes a plurality of signal processing channels (chs) such as input channels and output channels. In general, each ch is formed of a plurality of signal processing blocks. An equalizer (EQ) is one of such signal processing blocks, and is a block configured to adjust a frequency characteristic of an input signal. The setting of the frequency characteristic of the EQ is generally conducted through the display of a graph indicating the frequency characteristic. A user is allowed to set a gain and a Q of each band of the EQ while viewing a frequency characteristic graph by a method of, for example, operating predetermined operating elements (see, for example, the section of the EQ in DIGITAL MIXING CONSOLE M7CL, User Manual, 2005-2011, Yamaha Corporation).

### SUMMARY OF THE INVENTION

Incidentally, a user who is skilled in the setting of an EQ can set a frequency characteristic to obtain a desired sound by referring to a frequency characteristic graph to adjust a gain and the like of each band with a numerical value of a frequency as a guide. However, there is a problem in that it is difficult for a user who is not skilled in the setting of the EQ to know how to make an adjustment through use of only the frequency characteristic graph. For example, musical instruments have different frequency ranges, but it is difficult for a novice who does not know such differences in the frequency range among the musical instruments to set the frequency characteristic depending on the musical instrument.

Further, a skilled user grasps a frequency band distinctive of a musical instrument for each of musical instruments. The frequency band distinctive of a musical instrument represents a frequency band that can change an expression and an impression of a sound in such a manner that, for example, the musical instrument sounds more brilliant or heavier after an adjustment is made to the gain of this band. A novice does not grasp such a frequency band distinctive of a musical instrument, and therefore does not know which band is to be adjusted to obtain what kind of expression or impression for each musical instrument, and it is difficult for the novice to set the frequency characteristic depending on the musical instrument.

One or more embodiments of the present invention has an object to provide an EQ setting device that allows even a novice who does not grasp a frequency range of each musical instrument or a frequency band distinctive of each musical instrument to easily adjust a frequency characteristic of an EQ.

In order to achieve the above-mentioned object, a first aspect of the present invention provides an equalizer setting device configured to set a parameter of an equalizer configured to adjust a frequency characteristic of an input acoustic signal, the equalizer setting device including: a signal processing channel including an equalizer configured to adjust the frequency characteristic of the acoustic signal; a unit configured to set a category of the signal processing channel; a display unit; a unit configured to display a current setting state of the frequency characteristic of the equalizer on the display unit as a graph and to receive a predetermined operation of the user to adjust the frequency characteristic; and a unit configured to display, in addition to the graph displayed on the display unit, at least one of a display element indicating a frequency range corresponding to the category set for the signal processing channel or a display element indicating a distinctive frequency band corresponding to the category.

Further, the equalizer setting device may further include a unit configured to specify whether or not to display the at least one of the display element indicating the frequency range or the display element indicating the distinctive frequency band.

Further, in the equalizer setting device, the display element indicating the frequency range may indicate the frequency range with a representation that imitates a keyboard of a piano.

Further, in the equalizer setting device, the unit configured to display the at least one of the display element indicating the frequency range or the display element indicating the distinctive frequency band may be further configured to display a range of significant gain values within the frequency range and the distinctive frequency band.

In one or more embodiments of the present invention, an equalizer setting device includes a category information acquisition unit configured to acquire category information indicating a category set for a signal processing channel; and a unit configured to display, on a display unit, at least one of a display element indicating a frequency range corresponding to the category set for the signal processing channel or a display element indicating a distinctive frequency band corresponding to the category.

In one or more embodiments of the present invention, an equalizer setting method includes acquiring category information indicating a category set for a signal processing channel; and displaying at least one of a display element indicating a frequency range corresponding to the category set for the signal processing channel or a display element indicating a distinctive frequency band corresponding to the category.

In one or more embodiments of the present invention, anon-transitory computer-readable recording medium having stored thereon an equalizer setting program causes a computer to function as: a category information acquisition unit configured to acquire category information indicating a category set for a signal processing channel; and a unit configured to display at least one of a display element indicating a frequency range corresponding to the category set for the signal processing channel or a display element indicating a distinctive frequency band corresponding to the category.

According to one embodiment of the present invention, when the frequency characteristic of the equalizer is adjusted, the frequency range corresponding to the category set for the channel and the distinctive frequency band are displayed in addition to the graph indicating the frequency characteristic, and hence even a novice who does not grasp such a frequency range or such a distinctive frequency band can easily adjust the frequency characteristic.

### BRIEF DESCRIPTION OF THE DRAWINGS

FIG. 1 is a block diagram for illustrating a hardware configuration of a digital mixer according to one embodiment to which the present invention is applied.

FIG. 2 is a partial external view of an operation panel of a mixer according to the embodiment.

FIG. 3 is a block diagram of signal processing conducted by the mixer according to the embodiment.

FIG. 4 is a block diagram for illustrating a schematic configuration of an input channel within the mixer according to the embodiment.

FIG. 5A, FIG. 5B, and FIG. 5C are diagrams for illustrating examples of a home screen, a ch name setting screen, and an EQ detail screen.

FIG. 6A, FIG. 6B, and FIG. 6C are diagrams for illustrating examples of EQ detail screens of various categories.

FIG. 7A, FIG. 7B, FIG. 7C, FIG. 7D, and FIG. 7E are processing flows of a control CPU.

### DETAILED DESCRIPTION OF THE INVENTION

Now, an embodiment of the present invention is described with reference to the accompanying drawings.

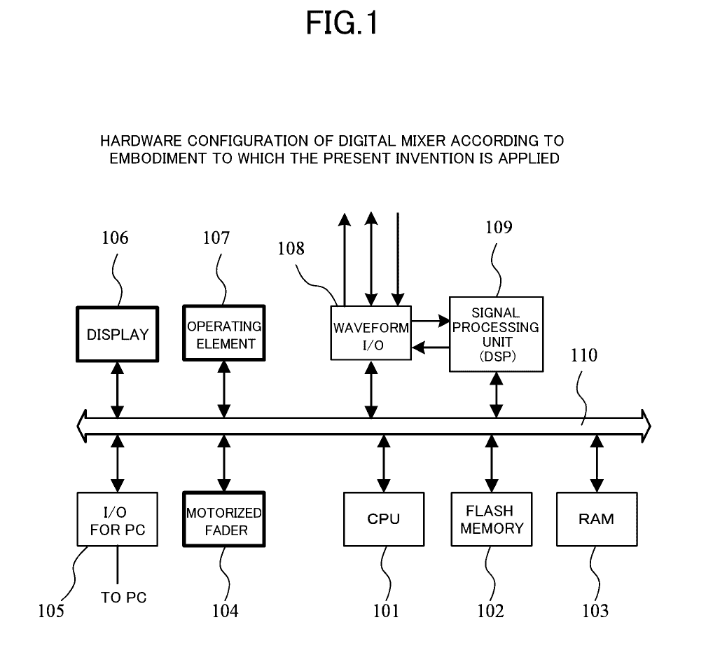

FIG. 1 is a block diagram for illustrating a hardware configuration of a digital mixer according to one embodiment to which the present invention is applied. A central processing unit (CPU) 101 is a processing unit configured to control the operation of the entire mixer. A flash memory 102 is a non-volatile memory configured to store various programs to be executed by the CPU 101, various kinds of data, and the like. A random access memory (RAM) 103 is a volatile memory for use in a load area and a work area for the program to be executed by the CPU 101. The RAM 103 includes a storage area called “current memory”, and the CPU 101 controls an operation of a signal processing unit 109 described later based on various parameters stored in the current memory. A motorized fader 104 is an operating element for level setting provided on an operation panel of the mixer. An input/output interface (I/O) 105 for a personal computer (PC) is an interface for connection to a PC.

A display 106 is a display configured to display various kinds of information provided on the operation panel, and is a touch panel capable of detecting a touch operation conducted by a user. An operating element 107 corresponds to various operating elements (such as a rotary encoder, a switch, a button, and the like other than the motorized fader) which are provided on the operation panel and which are to be operated by the user. Blocks expressed by the bold lines in FIG. 1 are components of the operation panel. An audio signal input/output interface (waveform I/O) 108 is an interface configured to exchange an acoustic signal with an external device. The signal processing unit (DSP) 109 executes various micro programs based on instructions issued by the CPU 101, to thereby conduct signal processing, such as mixing processing, effect addition processing, and volume level control processing, for the acoustic signal input through the waveform I/O 108, and outputs the processed acoustic signal through the waveform I/O 108. A bus 110 is a bus line for connecting those components, and generically refers to a control bus, a data bus, and an address bus. The term “signal” referred to in the present specification represents an acoustic signal (audio signal) unless otherwise specified (unless described as being a control signal).

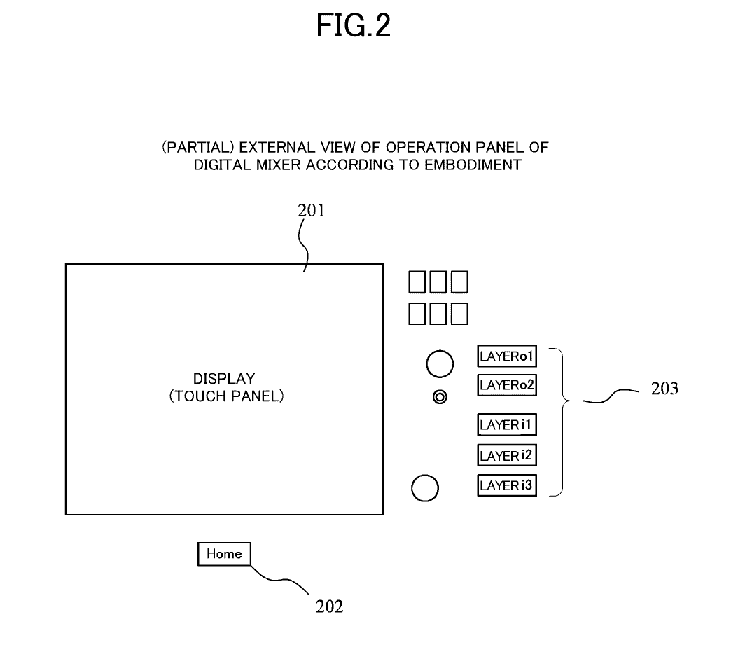

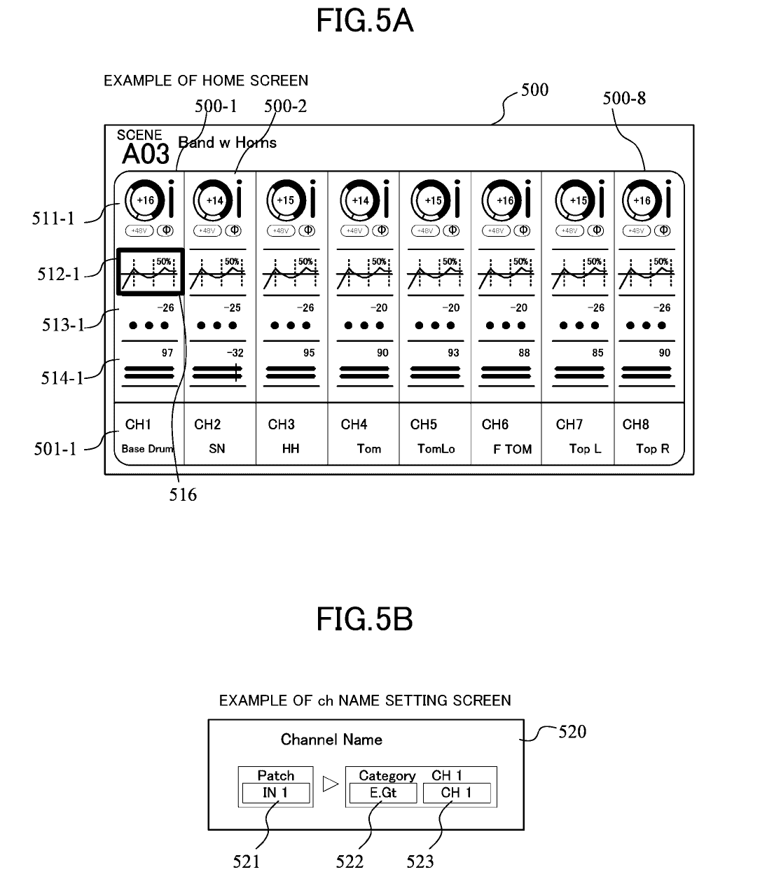

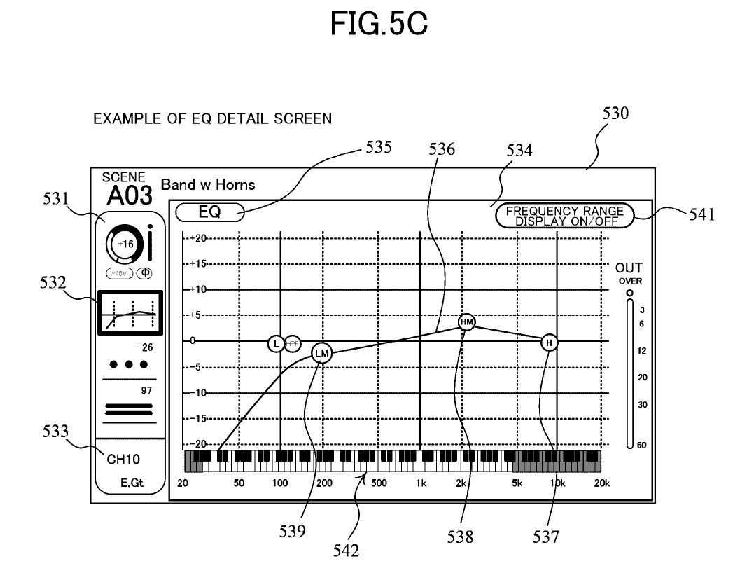

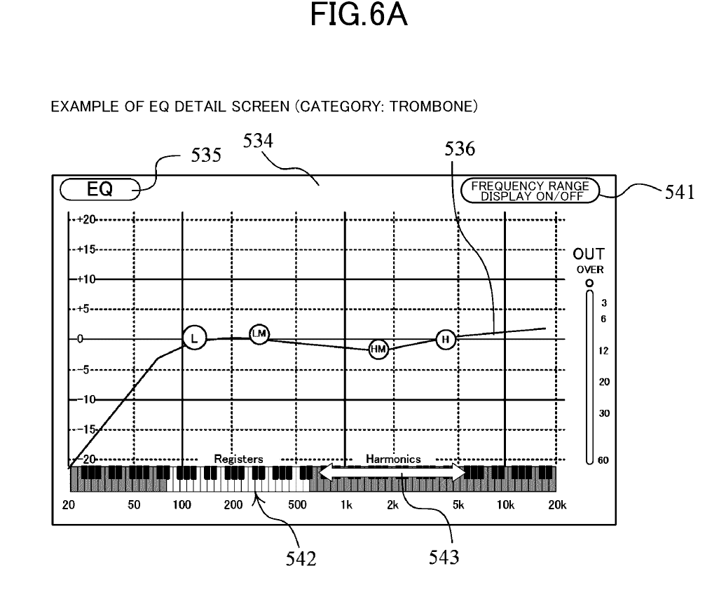

FIG. 2 is a (partial) external view of the operation panel of the digital mixer according to this embodiment. Various operating elements are arranged on the operation panel along with a touch panel 201 (display 106 of FIG. 1). A home button 202 is a button for an instruction to call a home screen, which is described later with reference to FIG. 5A, onto the touch panel 201. Of a plurality of layer buttons 203, layer buttons i1 to i3 are layer buttons for respectively calling home screens for respective layers of, for example, input channels (chs) 1 to 8 and input chs 9 to 16. Those layer buttons are controlled so that only any one layer button that was last pressed by the user is in an on state at all times.

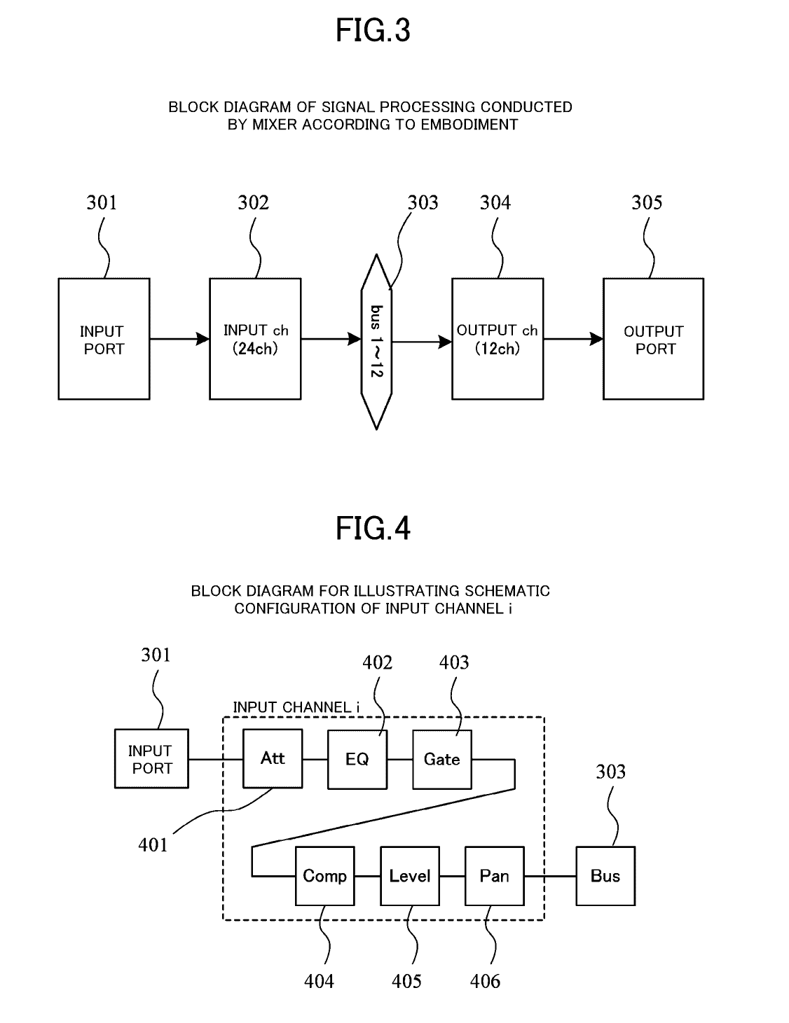

FIG. 3 is a block diagram of the signal processing conducted by the mixer according to this embodiment. The signal processing of FIG. 3 is realized by the waveform I/O 108 and the DSP 109 of FIG. 1. An input port 301 represents a plurality of input ports each configured to convert an analog acoustic signal input from a signal supply source, for example, a microphone or a musical instrument, into a digital acoustic signal, and to input the digital acoustic signal. An input ch 302 conducts signal processing, such as level control and frequency characteristic adjustment processing, for the digital acoustic signal input from each input port based on parameters set for each input ch within the current memory. In this case, 24 input chs are provided. Outputs from the respective input chs are mixed by a bus 303, and output to an output ch 304. Each output ch conducts various kinds of signal processing on an output side based on values of the parameters set within the current memory. The output port 305 represents a plurality of output ports each configured to convert the acoustic signal input from each output ch of the output ch 304 into an analog acoustic signal, and to output the analog acoustic signal.

FIG. 4 is a block diagram for illustrating a schematic configuration of signal processing blocks of one ch among the input chs 302. One ch includes an attenuator (Att) 401, an equalizer (EQ) 402, a gate (Gate) 403, a compressor (Comp) 404, a level (Level) 405, and a pan (Pan) 406. The signal processing conducted in each of the plurality of signal processing blocks is controlled by parameter values of a parameter set corresponding to the signal processing block, which are included in the parameters of the corresponding ch within the current memory. Although not shown, the output ch 304 is formed of signal processing blocks, for example, an equalizer, a compressor, and a level adjusting portion, and the signal processing conducted in each of the plurality of signal processing blocks is controlled by the parameters of the output ch within the current memory in the same manner.

FIG. 5A is an illustration of an example of a home screen for the layer of the input chs 1 to 8. A screen 500 indicating the home screen is displayed when the user turns on the home button 202 after turning on the layer button i1 to select the input chs 1 to 8. A home screen for another layer is displayed by an operation of the layer button and the home bottom in the same manner.

Vertically oriented display areas (hereinafter referred to as “ch display areas”) 500-1 to 500-8 serve to display parameter setting status of the input chs 1 to 8, respectively. In a given ch display area corresponding to one ch, for example, the ch display area 500-1, a ch-number-and-category display area 501-1 serves to display a ch number and a category of the input ch displayed in the given ch display area. The ch-number-and-category display area 501-1 is constantly displayed at the bottom of the home screen in a fixed manner. Four areas 511-1, 512-1, 513-1, and 514-1 serve to display parts of the parameters of the parameter set for the respective signal processing blocks of the Att 401, the EQ 402, the Gate 403, and the Comp 404 of the corresponding ch in the stated order (the area for displaying the parameters of one signal processing block is hereinafter referred to as “block display area”).

Only the ch display area 500-1 for the input ch 1 is described above, but the same applies to the ch display areas 500-2 to 500-8 for the input chs 2 to 8. The respective block display areas of the input ch 2 are represented by appending “−2” to the above-mentioned reference numerals 511 to 514 as a branch number, and in the same manner, the block display areas of the subsequent input chs are represented by appending “−3” to “−8” to the above-mentioned reference numerals 511 to 514 as branch numbers.

A cursor 516 is an indication expressed by the bold line of FIG. 5A. The user is allowed to set the cursor 516 at an arbitrary block display area within the displayed home screen by touching the block display area one time. The block display area at which the cursor 516 is set is referred to as a “selected” area or an area “in a selected state”. Further, an operation target ch of the block display area at which the cursor 516 is set is referred to as “selected ch”. The number of block display areas in a selected state on the screen is constantly only one. In FIG. 5A, the block display area 512-1 configured to display the parameters of the EQ within the ch display area 500-1, that is, the ch display area of the input ch 1 is in a selected state. When the user again touches the block display area in a selected state, a detail screen for setting the parameter set for the signal processing block of the selected ch corresponding to the block display area is displayed.

FIG. 5B is an example of a ch name setting screen 520 displayed by touching one of the ch-number-and-category display areas 501-1 to 501-8 displayed on the home screen 500 of FIG. 5A. In this case, the ch name setting screen 520 displayed by touching the ch-number-and-category display area 501-1 is illustrated, and hence a target ch for setting a ch name is set to the input ch 1. When an input port selection area 521 is touched, an input port for inputting a signal to the corresponding input ch can be switched. When a category selection area 522 is touched, the category of the corresponding input ch can be input. The category is a notion mainly indicating a kind of musical instrument (“vocal” indicating a human voice is also assumed as one kind of musical instrument). Information for plotting an EQ graph described later is stored for each category. The symbol “E.Gt” of FIG. 5B represents an electric guitar. When a ch name setting area 523 is touched to enable a selected state, the ch name can be arbitrarily input by a predetermined input unit (for example, software keyboard displayed on the screen or keyboard on the operation panel). The ch name setting screen 520 is closed by a predetermined operation to return to an original home screen 500. On the home screen 500, the indication of the ch name set by the user is omitted. For example, only the ch number and the category are illustrated in the ch-number-and-category display area 500-1.

FIG. 5C is an illustration of an example of the detail screen of the EQ displayed when the user further touches the block display area of the EQ of the input ch 10 while the block display area is in a selected state on the home screen. An area 531 on the left side of the screen is an area for displaying the same information as the information displayed in the above-mentioned ch display area in regard to the selected ch. In this case, the selected ch is the input ch 10, and hence an indication 533 that the current operation target is the input ch 10 is provided at the bottom of the area 531. It is understood from the indication 533 that the category of the input ch 10 is the electric guitar (E.Gt). Further, the cursor 532 is set at a parameter display area of the EQ within the area 531 because the detail screen of the EQ is currently being displayed.

A detail screen 534 allows the parameter set for the EQ to be set, and a heading indication 535 indicates that the detail screen 534 is a detail screen for setting the parameter set for the EQ. An EQ graph 536 is an indication of an EQ graph indicating the current setting state of the EQ within the selected ch. Pointers 537 to 539 indicate peak positions, which may be positions indicating local maximum value and local minimum values, of respective bands. When a swipe is conducted horizontally while one of those pointers is touched and held, the peak position can be adjusted in a frequency direction, and the gain in the peak position can be adjusted by a vertical swipe. The peak position of the pointer may be adjusted in the frequency direction and a gain direction not only by a swipe operation but also by an operation of, for example, a predetermined physical operating element on the operation panel. Further, only the adjustments of the peak position in the frequency direction and the gain direction are described above, but a Q can also be adjusted by a predetermined operation. The pointer is set in, for example, a position corresponding to a local maximum value or a local minimum value of an EQ graph.

On this EQ screen, apiano keyboard indication 542 is displayed. The frequency range display ON/OFF button 541 enables the piano keyboard indication 542 to be switched between a display (ON) state and a non-display (OFF) state. The piano keyboard indication 542 is displayed in order to indicate a frequency range, which may include ranges, sound ranges or registers, of a musical instrument of the category based on the category of the selected ch. In FIG. 5C, the category of the selected ch 10 is the electric guitar, and hence the frequency range of the electric guitar is displayed normally without being grayed out, while sections that are not included in the frequency range are displayed by being grayed out.

The display illustrated in FIG. 5C allows even a novice user to adjust the gain of each band of the EQ after recognizing the frequency range of the category (musical instrument) assigned to the processing target ch for the current EQ setting, to thereby be able to avoid the adjustment of a meaningless band that is not included in the frequency range of the musical instrument.

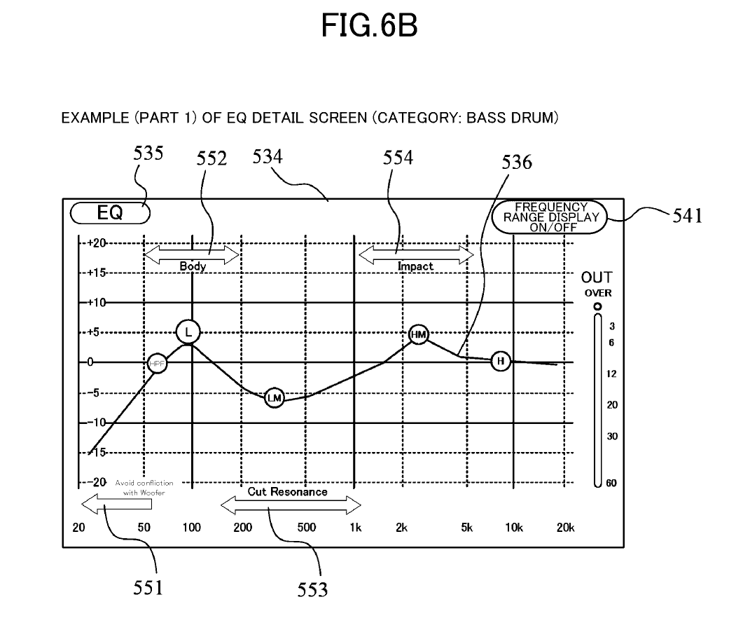

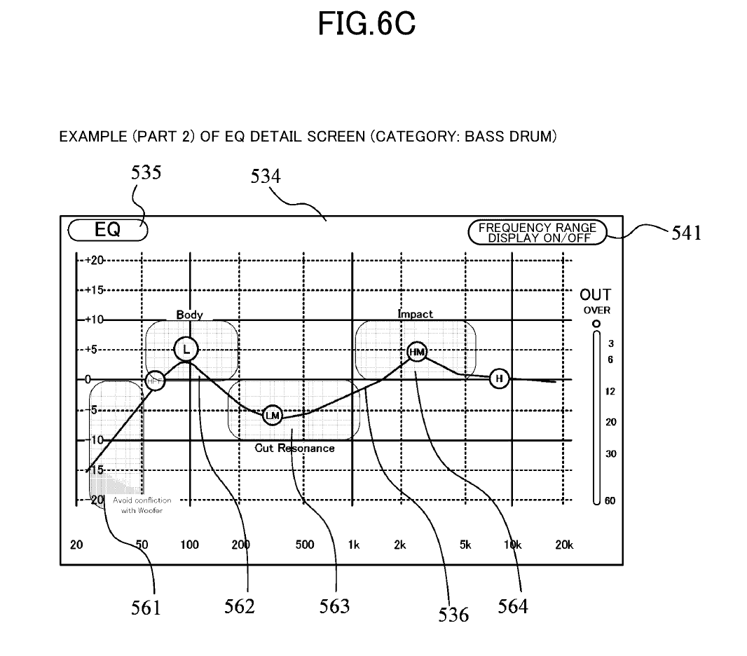

FIG. 6A is an illustration of an example of an EQ detail screen displayed when the category of the selected ch is a trombone. In FIG. 5C, the area 531 is illustrated on the left side of the detail screen 534, but is omitted in FIG. 6A (the same applies to FIG. 6B and FIG. 6C). The heading indication 535 and the frequency range display ON/OFF button 541 are the same as those of FIG. 5C. The EQ graph 536 is an indication of an EQ graph indicating the current setting state of the EQ within the selected ch for which the trombone is set as the category. Some pointers are displayed, and the gains of the respective bands are adjusted through the operations of those pointers.

The piano keyboard indication 542 displayed when the frequency range display ON/OFF button 541 is turned on is used for the same frequency range display as described with reference to FIG. 5C. In this case, the category is the trombone, and hence a section corresponding to the frequency range of a sound generated by the trombone is displayed normally, while sections that are not included in the frequency range are displayed by being grayed out. The characters “Registers” are displayed above a segment of the frequency range to indicate that the segment corresponds to the frequency range. In the case of the trombone, an impression of the sound is affected by gains of harmonic components in addition to the frequency range, and hence an arrow 543 is displayed to notify the user of a frequency band of the harmonic component. The characters “Harmonics” are displayed above a segment indicated by the arrow 543 to indicate that the segment corresponds to the range of harmonics.

The display illustrated in FIG. 6A allows the user to adjust the gain of each band of the EQ after recognizing the frequency band of the frequency range of the category (musical instrument) assigned to the processing target ch for the current EQ setting and the frequency band of the harmonic component, to thereby be able to avoid the adjustment of a meaningless band other than those frequency bands, and to further allow an intentional examination of, for example, how the sound is to be converted through the adjustment of the gain of the harmonic component.

FIG. 6B is an illustration of an example (Part 1) of an EQ detail screen displayed when the category of the selected ch is a bass drum. The heading indication 535 and the frequency range display ON/OFF button 541 are the same as those of FIG. 5C. The EQ graph 536 is an indication of an EQ graph indicating the current setting state of the EQ within the selected ch for which the bass drum is set as the category. Some pointers are displayed, and the gains of the respective bands are adjusted through the operations of those pointers in the same manner as in FIG. 5C and FIG. 6A.

In FIG. 5C and FIG. 6A, the piano keyboard indication 542 is display when the frequency range display ON/OFF button 541 is turned on, but there is no piano keyboard indication in FIG. 6B. This is because the category is the bass drum being a percussion instrument in FIG. 6B, and because the sound of the percussion instrument does not have such a pitch as expressed by a position in the keyboard of a piano. Arrows 551 to 554 are displayed instead when the frequency range display ON/OFF button 541 is turned on.

The arrow 551 indicates that the corresponding frequency band is a distinctive frequency band in which the gain is desirably lowered in order to avoid a conflict with a woofer. The arrow 553 indicates that the corresponding frequency band is a distinctive frequency band in which the gain is desirably lowered when a resonance is to be cut. The arrows 551 and 553 are displayed on the lower side of the EQ graph 536 because the direction of lowering the gain is meaningful. The arrow 552 indicates that the corresponding frequency band is a distinctive frequency band that forms a main body of the bass drum. The arrow 554 indicates that the corresponding frequency band is a distinctive frequency band in which the gain is desirably raised when an impact is to be exerted on the sound. The arrows 552 and 554 are displayed on the upper side of the EQ graph 536 because the direction of raising the gain is meaningful.

The display illustrated in FIG. 6B allows the user to adjust the gain of each band of the EQ after recognizing the distinctive frequency band of the bass drum. Therefore, even a novice can add expressions to the sound with ease, and it is also possible to avoid a conflict with the woofer and a resonance.

FIG. 6C is an illustration of an example (Part 2) of the EQ detail screen displayed when the category of the selected ch is the bass drum, and is a modified example of FIG. 6B. The heading indication 535 and the frequency range display ON/OFF button 541 are the same as those of FIG. 6B. In FIG. 6B, the distinctive frequency band of the bass drum is displayed by the arrows 551 to 554, but in FIG. 6C, the ranges indicated by the above-mentioned arrows 551 to 554 are expressed by rectangles 561 to 564. The rectangles 561 to 564 have the same lengths in a horizontal axis direction as the lengths of the above-mentioned arrows 551 to 554. In addition, the rectangles 561 to 564 each indicate, by a vertical length of each rectangle, how much gain is to be significantly increased or decreased in the corresponding frequency band. For example, a vertical range of the rectangle 564 indicates that the gain of the frequency band is desirably raised up to a range of approximately+10 dB in order to obtain the sound of the bass drum exerting an impact.

The method of expressing the frequency band and the range of the gain by a rectangle as in FIG. 6C is not limited to the case where the category is the bass drum, and can be applied to a case of another category. In this case, the frequency band and the range of the gain are expressed by the rectangle, but any indication method for notifying the user of a range of significant gain values within the frequency range corresponding to the category and the distinctive frequency band may be employed.

The above-mentioned display illustrated in FIG. 6C allows the user to adjust the gain of each band of the EQ after recognizing the distinctive frequency band of the bass drum, and also to know how much gain is to be significantly increased or decreased in the distinctive frequency band. Therefore, even a novice can accurately add expressions to the sound with ease, and it is also possible to accurately avoid a conflict with the woofer and a resonance.

The above descriptions are made by taking exemplary cases where the categories are the electric guitar, the trombone, and the bass drum, but the same applies to a case of another category. When the parameter setting of the EQ is conducted on the EQ detail screen of FIG. 5C, FIG. 6A, FIG. 6B, or FIG. 6C, the corresponding parameter values within the current memory are set to the values corresponding to the operation. All the parameter values (parameter set) for the respective signal processing blocks of the respective chs are held in the current memory, and in the background processing (not shown) of the CPU 101, parameter data within the current memory is constantly reflected in the signal processing of the DSP 109.

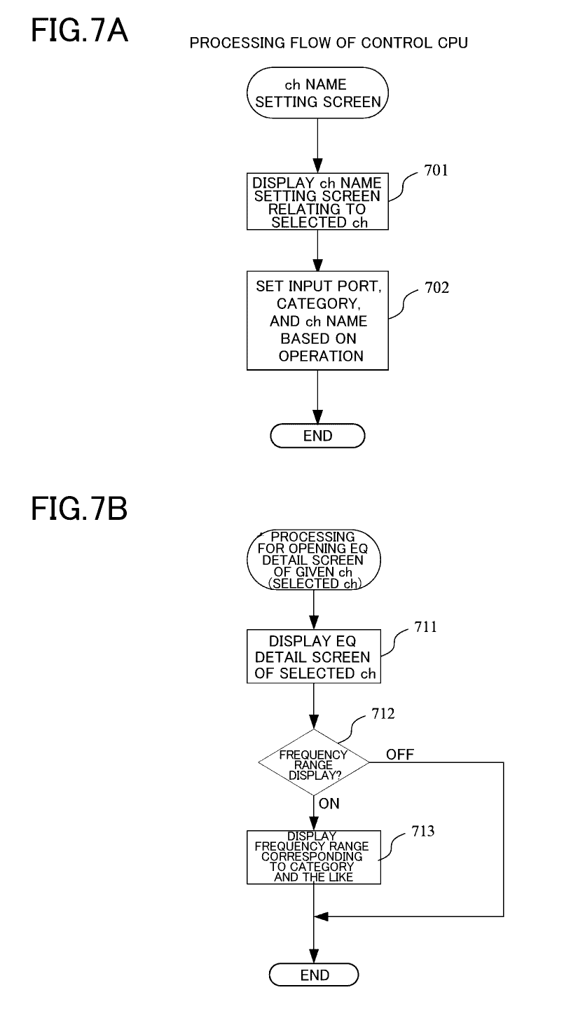

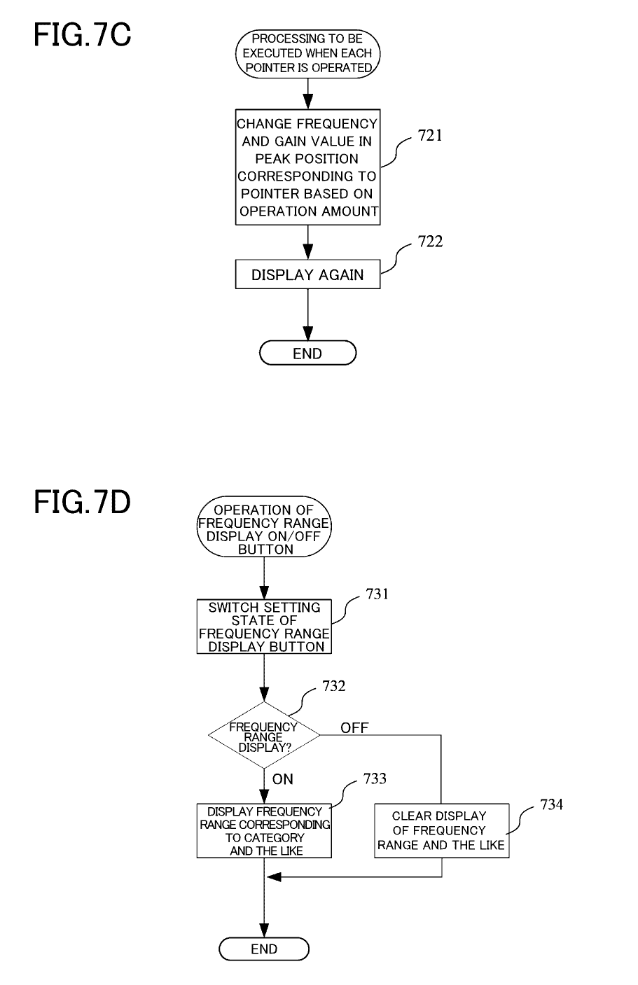

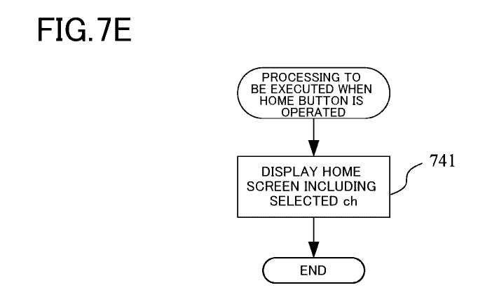

Next, a processing procedure of the control CPU 101 for realizing the above-mentioned operation is described with reference to FIG. 7A, FIG. 7B, FIG. 7C, FIG. 7D, and FIG. 7E.

FIG. 7A is a processing flow for a ch name setting screen. This processing is executed when one of the ch-number-and-category display areas 501-1 to 501-8 that corresponds to any ch (selected ch) is touched on the home screen 500 of FIG. 5A. In Step 701, the ch name setting screen relating to the selected ch illustrated in FIG. 5B is displayed. In Step 702, the input port, the category, and the ch name of the selected ch within the current memory are set based on an operation conducted on the ch name setting screen.

FIG. 7B is a flow of processing for opening the EQ detail screen illustrated in FIG. 5C, FIG. 6A, FIG. 6B, or FIG. 6C of a given ch (selected ch). This processing is executed when the user touches the block display area of the EQ of any ch (selected ch) within the home screen of FIG. 5A after the block display area is selected. In Step 711, the EQ detail screen of the selected ch illustrated in FIG. 5C is displayed. The EQ graph 536 is obtained by reading EQ parameters of the selected ch from the current memory and displaying the EQ parameters as a graph. In Step 712, the setting state of a frequency range display ON/OFF button for the EQ of the selected ch is determined. The setting state of ON/OFF of the button is held in the current memory. When the setting state is ON, for example, the frequency range corresponding to the category of the selected ch is displayed in Step 713. For example, the piano keyboard indication 542 of FIG. 5C is displayed when the category is the electric guitar, the piano keyboard indication 542 and the arrow 543 of FIG. 6A are displayed when the category is the trombone, and the arrows 551 to 554 of FIG. 6B are displayed when the category is the bass drum. When the setting state is OFF in Step 712, the above-mentioned display of Step 713 is not conducted, and the procedure is brought to an end.

When such display as illustrated in FIG. 6C is conducted through use of the rectangles, the display is conducted through use of the same rectangles as the rectangles 561 to 564 of FIG. 6C based on each category.

FIG. 7C is a flow of processing to be executed when each of pointers (for example, the pointers 537 to 539 of FIG. 5C) is operated on the EQ detail screen. In Step 721, the frequency and the gain value in the peak position corresponding to the operated pointer of the EQ of the selected ch within the current memory is changed based on the operation amount (moving amount of the pointer on the screen in vertical and horizontal directions). In Step 722, the EQ graph and the peak position are displayed again.

FIG. 7D is a flow of processing to be executed when the frequency range display ON/OFF button is operated on the EQ detail screen. In Step 731, the setting state of the frequency range display ON/OFF button within the current memory is switched. In Step 732, it is determined whether the frequency range display has been turned on or off. When the frequency range display has been turned on, in Step 733, the frequency range corresponding to the category of the selected ch and the like are displayed. When the frequency range display has been turned off, in Step 734, the display of the frequency range and the like is cleared.

FIG. 7E is a flow of processing to be executed when the home button 202 is turned on by the user. This processing is executed when the home button 202 is turned on irrespective of the screen displayed immediately before. In Step 741, the home screen illustrated in FIG. 5A including the selected ch at that time point is displayed.

The present invention is not limited to the embodiment described above, and the structure described in the embodiment may be replaced by substantially the same structure, a structure having the same action and effect, and a structure that may achieve the same object.

The above-mentioned embodiment is described by taking the EQ of the input ch of the mixer as an example, but the present invention can be applied to the EQ of the output ch of the mixer or another arbitrary ch of an arbitrary acoustic device, for example, a recorder, an amplifier, or speakers. Further, the above-mentioned embodiment is described by taking the mixer as an example, but the present invention can be applied to an audio editing application that runs on a tablet PC or the like. Specifically, for example, an equalizer setting device according to the above-mentioned embodiment may be formed of a smartphone or other such mobile terminals. In this case, for example, the setting of the EQ is conducted on a mobile terminal side, and is reflected in the digital mixer provided separately from the mobile terminal.

A display unit according to the above-mentioned embodiment is a touch panel including a touch sensor, but may be replaced by a display that does not include a touch sensor and a pointing device, for example, a mouse or a touch pad. Further, the frequency range display ON/OFF button is set as a button on the screen, but the on and off of the frequency range display may be switched merely by touching a margin within the range in which the EQ graph is displayed. In addition, in a display unit in which a mouse pointer is displayed on the screen, the above-mentioned frequency range or the like may be displayed when the mouse pointer enters the EQ detail screen. The frequency range display ON/OFF button may be formed of a physical button. Further, the category may be automatically set by the equalizer setting device instead of the user's operation. In this case, the category may be set by analyzing the waveform of the inputted audio signal. Further, the category may be set by an operation of a smart phone or a PC that is employed outside of the equalizer setting device, and the category of the equalizer setting device may be set by obtaining the information of the category.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An equalizer setting device, comprising:
a category information acquisition unit configured to acquire category information indicating a category set for a signal processing channel; and
a unit configured to display, on a display unit, at least one of a display element indicating a frequency range corresponding to the category set for the signal processing channel or a display element indicating a distinctive frequency band corresponding to the category.

2. The equalizer setting device according to claim 1, further comprising:
a signal processing channel comprising an equalizer configured to adjust a frequency characteristic of an input acoustic signal;
a unit configured to set the category for the signal processing channel; and
a unit configured to display a current setting state of the frequency characteristic of the equalizer, and to receive a predetermined operation of a user to adjust the frequency characteristic.

3. The equalizer setting device according to claim 1, further comprising a unit configured to specify whether or not to display the at least one of the display element indicating the frequency range or the display element indicating the distinctive frequency band.

4. The equalizer setting device according to claim 1, wherein the display element indicating the frequency range indicates the frequency range with a representation that imitates a keyboard of a piano.

5. The equalizer setting device according to claim 4, wherein the representation that imitates the keyboard of the piano comprises a representation in which a section corresponding to the frequency range corresponding to the category and a section corresponding to a range other than the frequency range corresponding to the category are distinguished from each other.

6. The equalizer setting device according to claim 1, wherein the unit configured to display the at least one of the display element indicating the frequency range or the display element indicating the distinctive frequency band is further configured to display a range of significant gain values within the frequency range and the distinctive frequency band.

7. The equalizer setting device according to claim 2, wherein:
the unit configured to adjust the frequency characteristic is further configured to display the current setting state of the frequency characteristic of the equalizer as a graph; and
the display element indicating the distinctive frequency band indicates an area within a predetermined range from a predetermined position of the displayed graph.

8. An equalizer setting method, comprising:
acquiring category information indicating a category set for a signal processing channel; and
displaying, on a display unit, at least one of a display element indicating a frequency range corresponding to the category set for the signal processing channel or a display element indicating a distinctive frequency band corresponding to the category.

9. A non-transitory computer-readable recording medium having stored thereon an equalizer setting program for causing a computer to function as:
a category information acquisition unit configured to acquire category information indicating a category set for a signal processing channel; and
a unit configured to display, on a display unit, at least one of a display element indicating a frequency range corresponding to the category set for the signal processing channel or a display element indicating a distinctive frequency band corresponding to the category.
